(19) United States
(12) Patent Application Publication
(10) Pub. No.: US 2026/0316641 A1
(43) Pub. Date: Oct. 15, 2026

(54) CHILD SEAT FOR MOUNTING ON A MOTOR VEHICLE SEAT

(71) Applicant: CYBEX GmbH, Bayreuth (DE)

(72) Inventor: Saurabh PATIL, Bayreuth (DE)

(21) Appl. No.: 19/112,042

(22) PCT Filed: Sep. 20, 2023
(86) PCT No.: PCT/EP2023/075875

§ 371 Date: Mar. 14, 2025

(30) Foreign Application Priority Data
Sep. 23, 2022 (DE) 20 2022 105 368.5

(51) Int. Cl. B60N 2/28

(52) U.S. Cl. CPC B60N 2/2884

(57) ABSTRACT

Disclosed is a child seat for mounting on a motor vehicle seat, wherein the child seat comprises at least one side surface and a side impact protector. The side impact protector comprises a side impact protector base, as well as a side element which is movable with respect to the side impact protector base and can be transferred from a inoperative position to a functional position, wherein, in the functional position, the side element projects over the side surface in the lateral direction, wherein the side element in the inoperative position does not project over the side surface or projects less far than in the functional position, Position transfer means are provided to enable a transfer from the inoperative position to the functional position and are configured in such a way that, in a first step, a lateral projection over the side surface can be at least substantially determined and, in a second step, the side element is displaceable, in particular slidable, preferably in such a way that the side element comes to rest at least in sections over a portion of the side surface adjacent to the side element.

### DESCRIPTION

The invention relates to a child seat for mounting on a motor vehicle seat, as well as a method for adjusting the side impact protector of a child seat. A child seat is already known from EP 2 275 303A1, in which a side impact protector can be transferred from an inoperative to an operative position. In principle, for the same purpose, DE 10 2015 214 910 A1 also discloses side elements that can be transferred from a inoperative position to an functional position, wherein in the functional position the side element referred to therein as a side protection block is locked by means of a button referred to as a protection component, wherein this button is to be pressed in order to be able to fold in the side element or release a locking in the unfolded state. In the folded-in position of the protection component, the button is recessed within the protection component.

The solutions in the prior art are considered to be in need of improvement from a safety point of view, wherein in particular the risk that the side impact protector is not correctly in an operative position when the child seat is in use is considered to be high.

It is an object of the invention to propose a side impact protector for a child seat that features an adjustable side impact protector in a simple, safe and yet cost-effective manner. In particular, it is an object of the invention also to propose a side impact protector with easy handling. Furthermore, it is an object of the invention is to propose a corresponding method.

This object is solved in particular by the features of claim 1.

In particular, the object is solved by a child seat for mounting on a motor vehicle seat, wherein the child seat has at least one side surface and one side impact protector (whereby the side impact protector can be formed at least partially by the side surface or can be formed completely in addition to the side surface), wherein the side impact protector comprises: a side impact protector base, as well as a side element that is movable (in particular rotatable and/or displaceable) with respect to the side impact protector base, which can be transferred between an, in particular located within a predetermined width of the child seat, inoperative position (resting position) and a, in particular located outside the predetermined width, functional position (and vice versa), wherein the side element in the functional position projects over the side surface in the lateral direction, wherein the side element in the inoperative position does not project over the side surface or projects less far than in the functional position, wherein position transfer means (designed for manual and/or automatic operation) are provided to enable transfer from the inoperative position to the functional position, wherein the position transfer means are preferably configured such that, in a first step, a lateral projection over the side surface can at least substantially be determined and in a second step, the side element or at least one displacement portion of the side element, the weight of which preferably corresponds to at least 15 wt.-% (more preferably at least 25 wt.-% or at least 50 wt.-% or at least 90 wt.-%, optionally 100 wt.-%) of the total weight of the side element and/or which is at least partially visible in the inoperative position (as viewed from the outside), (wherein ‘partially’ preferably means that at least 0.5cm² , preferably at least 1.0cm² , optionally at least 2.5 cm² or at least 5.0 cm² of a surface is visible), is displaceable, in particular (translationally) slidable, preferably in such a way that the side element comes to rest at least in sections (if appropriate directly, in particular in contact) over (on) a portion of the side surface adjacent to the side element.

Preferably, the length of the displacement portion corresponds to at least 30%, preferably at least 50%, optionally at least 70% or at least 90%, optionally at least 100%, of the length of the entire side element. Alternatively or additionally, the width of the displacement portion can correspond to at least 30%, preferably at least 50%, optionally at least 70% or at least 90%, optionally at least 100% of the width of the entire side element. Alternatively or additionally, the height of the displacement portion can correspond to at least 30%, preferably at least 50%, optionally at least 70% or at least 90%, optionally at least 100% of the height of the entire side element. Alternatively or additionally, a (maximum) diameter (understood as the distance between the pair of points of the displacement portion or correspondingly referenced element/structure with the largest distance to each other) of the displacement portion correspond at least 30%, preferably at least 50%, optionally at least 70% or at least 90%, optionally at least 100% of the (maximum) diameter of the entire side element.

One idea of the invention is to divide the kinematics of the side element into two steps during the transfer from the inoperative position to the functional position. In particular, in a first step, the side element is brought at least substantially into its end position, insofar as its extension or protrusion in the lateral direction is concerned (i.e. in particular outwards or in a direction that is horizontal when in use, perpendicular to the child's line of vision or in a horizontal direction perpendicular to the direction of travel when the child seat is properly arranged), In the second step, a displacement occurs in particular such that the side element comes to lie over the side surface (in sections), in particular directly.

The term ‘over’ is intended to imply in particular that a projection of the side element overlaps with a portion of the side surface that is adjacent to the side element (when the projection is made onto this adjacent portion). One direction of the projection preferably corresponds to a surface normal on the adjacent portion. The overlap area preferably has an area of at least 0.5 cm² , preferably at least 1 cm², optionally at least 2.5 cm² and/or at most 40 cm² or at most 25 cm² or at most 10 cm², optionally at most 5 cm².

The position transfer means (or position transfer enabling means) are understood to mean, in particular, those structures of the child seat that help to enable position transfer. For example, the position transfer means may comprise at least one sliding surface and/or at least one stop and/or at least one bearing, e.g. a sliding bearing. The position transfer means can also comprise at least one drive, e.g. at least one spring. The position transfer means can be configured to enable transfer by manual and/or automatic operation.

The side surface is, in particular, a surface directed outwards (at least substantially away from the child or an accommodation space for the child).

A distance of the adjacent portion of the side surface from the side element in the functional position can be (in a direction parallel to the surface normal on the adjacent portion of the side surface) at most 1 cm, preferably at most 0.5 cm, more preferably at most 2 mm, more preferably at most 1 mm. Optionally, the distance can be zero, or optionally, the side element and the adjacent portion of the side surface can touch each other at least at certain points in the functional position.

According to the invention, the side element itself (or at least significant parts of it, for example in contrast to the relocation of the comparatively small and therefore less robust button of DE 10 2015 214 910A1, is displaced in an advantageous manner in order to lock the side element in a functional position in a side impact situation (in that it is prevented by the adjacent portion of the side surface from shifting towards the child). Preferably, the side element and/or its displacement portion is/are movable at least substantially transversely to the lateral direction and/or (at least in sections) at least substantially along the adjacent (outward-facing) side surface during the second step. In particular, an essentially transverse movement is understood to mean that one direction of movement forms an angle of 90°±30°, preferably 90°±10°, even more preferably 90°±5°, with the lateral direction (as defined above). In particular, movement essentially along the adjacent side surface is to be understood as movement having a direction at least substantially parallel to the adjacent side surface (wherein, in particular, a difference in direction is at most 30°, preferably at most 10°, even more preferably at most 5°. If the movement is a rotation, in particular, the direction of movement of at least one point (optionally all points) of a surface of the side element that is (are) opposite the adjacent portion of the side surface is to be taken into account. Such a point will follow a circular path in the case of a pure rotation. In general, the movement in the second step can be (purely) translational and/or (purely) rotational. In this respect, the respective condition above should apply for at least 30%, optionally at least 80% or at least 95% of the total length of the (possibly curved or straight) path of movement.

The inoperative position (resting position) is preferably a stowing position in which the side element offers no or only slight protection (compared to the functional position) in the event of a side impact. In the functional position (operative position or also use position), the side impact protection function of the side element is significantly increased (compared to the inoperative position). The inoperative position will also be referred to below as first position, and the functional position as second position. In particular, the early connection of the child seat (as well as of a child accommodated in the child seat) to the accident dynamics can be regarded as protection in the event of a side impact.

According to embodiment, a child seat is proposed with at least one side surface and one side impact protector, wherein the side impact protector comprises: a (side impact protector) base, and a side element that is movable with respect to the base, wherein the side element is transferable (reversibly) with respect to the base between a first position and a second position, wherein in the second position the side element projects over the side surface in the lateral direction, wherein in the first position the side element does not project over the side surface or projects less far than in the second position, whereby the transfer between the first position and the second position comprises a first step and a second step, wherein in the first step the lateral projection is determined, and wherein in the second step the side element (or its above displacement portion) is moved at least substantially transversely to the lateral direction and/or at least substantially along the side surface.

The child seat can have a seat area and a backrest. Advantageously, it can also have a headrest. The child seat can, According to embodiment, also include a seat base. Other features, such as restraint means for restraining a child (e.g. a harness and/or an impact shield), can be provided alternatively or additionally.

The seating area preferably forms a seat surface for supporting the child's bottom (and possibly also parts of the thighs) and may have first side surfaces. Alternatively or in addition, the seat area can comprise arm rests, which can extend at least substantially above the seat area, wherein lap belt guides for guiding the lap belt of a vehicle belt can be provided, in particular between the arm rests and the seat area, The child seat can comprise fastening means for fastening to a vehicle seat, in particular Isofix connectors and/or LATCH connectors and/or comparable means. The fastening means can be provided at a rear and/or lower end of the seat area. In embodiments with a seat base, the fastening means can alternatively or additionally be provided at a rear and/or lower end of the seat base.

The backrest can be designed integrally with the seat area and rigidly connected to it, or it can be movable with respect to the seat area-in particular adjustable in terms of inclination. Furthermore, the backrest forms a back contact surface for a child's back to rest against and/or be supported by and preferably includes second side surfaces (of which preferably at least one side surface is combined with the side impact protector explained above and/or below). The backrest can have side bolsters, which can be integrally formed with the portion of the backrest forming the back contact surface and can be rigidly connected to it, or which can be movable with respect to the back contact surface, in particular adjustable in terms of a width. The second side surfaces can be formed, in particular completely or partially, by portions of the side bolsters.

The optional headrest can be formed integrally with the backrest and be rigidly connected to it, or it can be movable with respect to the backrest, in particular adjustable in terms of inclination and/or distance of the headrest to the seat area. Furthermore, the headrest can form a head contact surface for supporting a child's head and can form third side surfaces. It can have side wings which can be formed integrally with the portion of the headrest forming the head contact surface and can be rigidly connected to it, or which can be movable with respect to the head contact surface-in particular adjustable in width. The third side surfaces can be formed, in particular completely or partially, by portions of the side wings. Shoulder belt guides can be provided on the headrest, in particular on the side wings and preferably at their lower end.

In versions with a seat base, the seat base can form fourth side surfaces. The seat surface and back contact surface, as well as optionally head contact surface and insides of armrests and/or side bolsters and/or side wings define an accommodation area (accommodation space) for a child. Each of the first to fourth side surfaces can (electively) be combined with the side impact protector explained above and/or below or form the side surface according to claim 1.

In the context of the present application, the term child seat is to be understood as covering all types of child seat, for example baby car seats or booster seats (and the like). Furthermore, directional information (such as front, back, right, left, up, down, inside, outside, sideways, etc.) should be understood as reflecting the perspective of a child regularly accommodated in the child seat and looking straight ahead. Insofar as children and their body parts are referred to, the reference can equally apply to dummies, in particular dummies of the company Humanetics (in accordance with the version that is or was current at the time of filing or priority), for example, dummies from the Q series. In particular, a suitable dummy can be selected from these dummies depending on the size of the seat, for example a Q0, Q1, Q1.5, Q3, Q6 and/or Q10, where the number after the Q corresponds to the approximate age of a child of comparable size and weight.

In particular, the child seat has side impact protector, which is described in detail below. In particular, the side impact protector has a side impact protector base, as well as a side element that can be moved in relation to the side impact protector base, whereby it is preferably envisaged that the side element can be reversibly transferred between a first position (stowing position and/or retracted position) and a second position (use position and/or extended position). In the second position, the side element projects over a side surface (or an adjacent portion thereof) of the child seat, whereas in the first position the side element does not project over the side surface or projects less far than in the second position. The side surface is preferably a second side surface, but According to embodiment, reference can also be made to a first, third and/or fourth side surface.

Preferably, the side element in its second position is the part of the child seat that projects the furthest to the side.

The transition between the first position and the second position of the side element preferably comprises a first step in which the lateral projection is (at least substantially) stopped and a second step in which the side element is moved (at least substantially) transversely to the lateral direction and/or along the side surface.

The transition from the first position to the second position preferably comprises first the first step and then the second step, Transfer from the second position to the first position preferably comprises first the second step and then the first step.

Preferably, the side impact protector is attached, in particular fastened, to the side of the child seat or to the side surface of the child seat (which in particular should not exclude the side impact protector also being at least partially further in than adjacent portions of the side surface).

It may be provided that the side impact base or a base outer surface is formed entirely or partially in one piece, in particular integrally, with the side surface. The side surface and side impact base may merge into one another.

The side impact base may comprise a frame that can form an opening. The frame may be a portion of the side surface framing the opening (the optional function of which is described in more detail below). The side impact base may further include portions that completely or partially close the opening inwards. The opening may, for example, be completely or partially formed as a blind hole or as a through-hole in the side surface and/or in the base. According to embodiment, the side impact base may include portions spanning across the opening like a bridge or a web and/or portions extending into the opening like a platform. The side impact base is preferably configured to co-operate with the side element to provide one or several functions of the side impact protector.

The side element may have a side element outer surface that is visible (i.e. not covered by other parts of the child seat) in the first position and that can, for example, completely or partially close the opening of the side impact base in the first position. In the first and/or second position, the side element outer surface may be directed at least substantially away from the child. Furthermore, the side element can have an inner surface that is (substantially) not visible in the first position, for example because it is covered by other parts of the child seat. The inner surface can be designed as an edge surface, at least in sections, and it can be provided that the inner surface is visible (preferably only partially) in the second position. In the first and/or second position, the inner surface can be directed at least substantially away from the child (optionally without taking the edge surface into account).

The side element can be made up of several sub-elements. For example, it can comprise an outer part that forms the outer surface. It can also comprise an inner part that enables it to interact with the base, which is explained in more detail below.

Preferably, the side element is rotatable (in particular, solely) about an axis, in particular a fixed or movable axis, during the first step.

Alternatively or additionally, the side element (or its displacement portion) is displaceable (in particular, solely) during the second step. Alternative or additional types of movement are explained below.

The side element is preferably designed as a folding element (flap) that can be folded about a (fixed or movable) axis, in particular in order to carry out the first step of the transfer between the first position and the second position. In this case, the rotation can also be superimposed by a translation (or vice versa), According to embodiment, the first step can be performed by a (pure) translation. Alternatively or additionally, the second step can be performed by a (pure) rotation.

Both steps can be performed by a (pure) translation, wherein the corresponding displacement axes or displacement directions can differ (for example by at least 10° or at least 45° or at least 80°).

Both steps can be performed by a (pure) rotation, wherein the corresponding axes of rotation can differ (for example by at least 10° or at least 45° or at least 80°).

The side element may include a proximal portion near the axis, and the side element may include a distal portion that is further from the axis than the proximal portion and that is further outward (further from the receiving area) than the axis in the second position. The axis may be physically formed, for example as a separate component. However, the axis may also be a fictitious axis, e.g. a film hinge.

The second step is preferably performed as a translation of the side element. In this case, the side element can slide on the side impact protector base and/or on the side surface of the child seat. Alternatively, the second step can be performed as a rotation. Preferably, one of the first and second steps comprises a rotation and the other of the first and second steps comprises a translation.

As already described, in a particularly preferred variant the first step comprises (in particular exclusively) a folding, while the second step comprises (in particular exclusively) a translation. In another preferred embodiment, the first step comprises (in particular exclusively) a translation, while the second step comprises (in particular exclusively) a rotation.

As described above, an axis can be provided for forming the folding mechanism, which can be fully or partially formed as a physical axis. The side element can comprise a side element axis reception, in which the axis can be mounted. The side impact protector base can comprise (in particular in a rear portion) a base axis reception, in which the axis can be mounted. The side element axis reception and/or the base axis reception can be formed to allow a translation of the side element with respect to the side impact protector base in at least one, preferably exactly one, folding position of the side element with respect to the side impact protector base. For this purpose, the side element axis reception and/or the base axis reception can have at least one, preferably at least two, elongated holes in which the axis can slide. The alignment of the slot/slots can be selected such that a sliding of the axis in the (respective) slot is only possible when the side element is in a position between one, in particular the one mentioned in the following, intermediate position (if, starting from the first position, the first step has been taken, or if, starting from the second position, the second step has been taken) and the second position.

The second step may comprise a translational movement of the axis in one of the side element axis reception and the base axis reception, The second step may also comprise a movement, in particular a translational movement, of the entire side element (or at least substantial portions thereof, e.g., at least 15 wt.-% or at least 50 wt.-% or at least 90 wt.-% thereof) with respect to the side impact protector base. With regard to the proximal portion, the movement can be guided by the axis and axis reception. The distal end can slide on the side impact protector base, in particular on a front portion of the side element. For this purpose, the side impact protector base can have a sliding portion that can guide the side element (between the intermediate position and the second position, at least in sections). The side impact protector base can comprise a base holding portion, which can be provided in particular adjacent to the sliding portion and/or at the front portion of the side impact protector base. The side element can comprise a side element holding portion, in particular at the distal end, wherein the side element holding portion can be supported on the base holding portion in the second position.

Preferably, the first step and/or the second step (if necessary after releasing a respective lock) is/are self-actingly (or automatic), preferably supported by at least one or exactly one spring (or other drive), or at least two or exactly two springs, further preferably by at least one first spring for assisting the second step and/or at least one second spring for assisting the first step.

The side impact protector can comprise a first spring that drives the side element to be transferred completely into the second position (in particular from an intermediate position in which, according to the first step, a projection over the side surface has already been at least substantially adjusted). The first spring may, for example, be a coil spring (e.g. a compression spring or a tension spring), a leg spring, a leaf spring or another suitable elastic element. The first spring may have two ends, with which it can support itself, on the one hand, on the side element and, on the other hand, on another element of the child seat, in particular on the side impact protector base. For this purpose, a first side element spring attachment can be provided on the side element, and a first base spring attachment can be provided on the side impact protector base. The first side element spring attachment and/or the first base spring attachment can be designed as a projection, in particular at least approximately cylindrical, onto which the first spring can be put on. However, depending on the type of spring used, other designs are also possible, such as, in particular groove-like, recesses into which the respective end of the spring can be inserted. The embodiments described in connection with the second spring below are also possible.

The function of the first side element spring attachment or first base spring attachment, in particular, is to enable stable support of the first spring on the respective element in order to enable safe and error-free execution of the second step.

The side impact protector may comprise a second spring that preferably drives the side element to be transferred to the intermediate position in which, according to the first step, a projection over the side surface is at least substantially adjusted. Alternatively, but not preferentially, the second spring can be designed to transfer the side element (in particular from an intermediate position, in which a projection over the side surface is at least substantially adjusted according to the first step) completely into the first position. The second spring may, for example, be a coil spring (e.g. a compression spring or a tension spring), a leg spring, a leaf spring or another suitable elastic element. The second spring may have two ends, with which it can support itself on the side element on the one hand and on another element of the child seat, in particular on the base, on the other. For this purpose, a second side element spring attachment may be provided on the side element, and a second base spring attachment may be provided on the side impact protector base. The second side element spring attachment and/or the second base spring attachment can be designed to allow the second spring to be engaged or encompassed (e.g. hooking a hook-like end of the second spring into a hole or encompassing a projection with a ring-like end). However, other embodiments are also possible, depending on the type of spring used, in particular those described in connection with the first spring.

The function of the second side element spring attachment or second base spring attachment, in particular, is to enable stable support of the second spring on the respective element to enable safe and error-free execution of the first step.

Preferably, the side impact protector is designed so that the first and second springs completely transfer the side element from the first position to the second position. The second spring can drive the side element to perform the first step starting from the first position to adjust the side element so that it projects further over the outer surface than in the first position. The first spring can drive the side element to perform the second step in order to prevent a lateral inward force from moving the side element to the first position against the action of the second spring.

The side impact protector may be configured such that the transition from the first position to the second position (after a first initiation of the transition, as explained in more detail below) is entirely spring-driven, in particular by the first and second springs. The transition from the second position to the first position occurs during the second step preferably against the force of the first spring. During the first step, the transfer from the second position to the first position can occur against the force of the second spring.

According to embodiment, the first spring and the second spring can be formed by a single combined spring. It can also be provided that only one second spring is provided. Each first spring, each second spring and each combined spring can comprise (exactly) one or several spring elements. However, preferably there should be (exactly) one first spring and (exactly) one second spring, which are each realised by exactly one spring element.

Preferably, the functional position lockable (against a transfer to the inoperative position, in particular against folding in). Alternatively or additionally, the inoperative position is lockable (against a transfer to the functional position, in particular against folding out). A locking is understood to mean, in particular, that the side element (at least not without overcoming a force threshold of, for example, at least 0.5 N or at least 1 N or at least 10 N or at least 100 N) can move in the direction of the respective other position of inoperative and functional position, in particular in any direction, before a corresponding locking mechanism is released.

The side element may comprise a side element stop, and the side impact protector base may comprise a base stop. The side element stop and the base stop may be adapted to co-operate to limit outward movement of the side element. In particular, after the first step, during the transfer from the first position to the second position, and/or in the second position, the side element can abut against the side element stop at the base stop. In the first position, the side element stop can be spaced apart from the base stop.

In the first position, a further inward displacement of the side element, in particular a further folding-in of the side element, can be at least substantially prevented (optionally except for a slight remaining displaceability, see below) in that the side element abuts the side impact protector base, at least in sections.

The side impact protector may further comprise a holding device to hold the side element in the first position. This is particularly useful if, as described above, a second spring is provided that is pretensioned in the first position of the side element to drive the side element to (further) project over the side surface in the lateral direction. The holding device can comprise a side element holding device and a base holding device. Preferably, one of the side element holding device and the base holding device engages with the other of the side element holding device and the base holding device to hold the side element in the first position. The engagement can be released to initiate the transfer of the side element from the first position to the second position. According to embodiment, for example, one of the side element holding device and the base holding device can comprise a latch, and the other of the side element holding device and the base holding device can comprise a latch reception.

It may be provided that the holding device is designed in such a way that the transfer of the side element from the first position to the second position is initiated by pressing inwards (in the direction of the accommodation space or child). To this end, it may be provided that the side element can be displaced slightly further inwards beyond the first position in order to release the side element from the first position and/or to release the engagement of the holding device.

Specifically, the side element holding device can comprise a projection, in particular comprising a head. The base holding device can comprise a guide portion that is provided by structures of the side impact protector base, e.g. by structures of the bridge, or that can be provided as a separate component in a holding device reception. A movable portion can be provided in the guide portion, which can in particular comprise at least or exactly one or at least or exactly two arms, which are preferably designed to be resilient. The at least or exactly two arms can be designed to define an opening without an external force, into which the side element holding device, in particular the head, can be inserted. The movable portion can assume an extended position with respect to the guide portion, in which no force acts on the arms, and the movable portion can assume a retracted position with respect to the guide portion, in which the guide portion compresses the arms (against the spring force) in order to encompass the side element holding device, in particular the head, in a holding manner. A mechanism known per se can be used to switch between the extended position and the retracted position (for example, as in a ballpoint pen).

Preferably, the side element and the side impact protector base comprise a pair of mutually complementary engagement structures, in particular at least one projection-recess-pair, which impedes a transfer from the functional position to the inoperative position, preferably such that the inhibition can be overcome by a force of less than or equal to 50 N, more preferably less than or equal to 10 N and/or greater than or equal to 0.1 N, preferably greater than or equal to 0.5 N, optionally greater than or equal to 1 N.

The side impact protector base can have a base holding engagement (e.g. a recess), in particular on the base holding portion. The side element may comprise a side element holding engagement (e.g. a projection), in particular on the side element holding portion. In the second position of the side element, one of the base holding engagement and side element holding engagement may engage in the other of the base holding engagement and side element holding engagement in order to impede the movement of the side element (away from the second position).

It may be provided that the transfer of the side element from the second position to the first position is initiated by pressing or pushing on the side element (and/or turning the side element), in particular opposite to the direction in which the first spring drives the side element. It may be provided that the side element is thereby moved (slightly) away from the side surface in order to release the base holding engagement and the side element holding engagement from one another. It may further be provided that the transfer of the side element from the second position to the first position is completed by pushing the side element, in particular the distal portion of the side element, inwardly.

Preferably, the side element is foldable backwards during the first step (in particular such that, when viewed from above, a side element mounted on the right side of the child seat folds in a clockwise direction and a side element mounted on the left side of the child seat folds in an anticlockwise direction). Alternatively or in addition, the side element or its displacement portion can be displaced forward during the second step.

Preferably, the side impact protector is designed and attached to the child seat in such a way that when the side element is transferred from the first position to the second position, the movement of the side element in the second step is not backwards (but preferably forwards). If it moves backwards, there is a particular risk that the side element will hit the backrest of the vehicle and/or an object located near the backrest in the second step and may not reach the second position. In addition, the side element may be difficult to access to release it from the second position because the backrest of the vehicle and/or the object is in the way.

The side impact protector is preferably provided at least partially, optionally completely, in a back portion of the child seat, in particular to the rear of a back contact surface, and/or above a seat portion (optionally above a level of an uppermost point of the seat portion) of the child seat and/or on an outer side of a seat shell of the child seat.

Preferably, the side element is made of an at least substantially rigid material. In particular, it may be hard plastic such as PE and/or PP or the like.

The above-mentioned object is further achieved by a method for adjusting a side impact protector of a child seat of the above-mentioned type, wherein the child seat has at least one side surface and a side impact protector, wherein the side impact protector comprises:
a side impact protector base, as well as
a side element that is movable (in particular rotatable and/or displaceable) with respect to the side impact protector base and can be transferred between an inoperative position, in particular located within a predetermined width of the child seat, and a functional position, in particular located outside the predetermined width, (and vice versa),
   wherein the side element projects further over the side surface in the functional position than in the inoperative position, wherein preferably in a first step a lateral projection over the side surface is at least substantially established and in a second step at least one portion of the side element, the weight of which preferably corresponds to at least 15 wt.-% (more preferably at least 25 wt.-% or at least 50 wt.-% or at least 90 wt.-%, optionally 100 wt.-%) of the total weight of the side element and/or which is at least partially visible from the outside in the inoperative position, is displaced, in particular slid, preferably in such a way that the side element comes to rest at least in sections over (preferably on) a portion of the side surface adjacent the side element. Further method features arise from the above description of the child seat, whereby functional features can be carried out as corresponding method steps.

Further embodiments arise from the dependent claims.

The invention is described in the following on the basis of examples of implementation, which are explained in more detail by means of the figures. Hereby show:

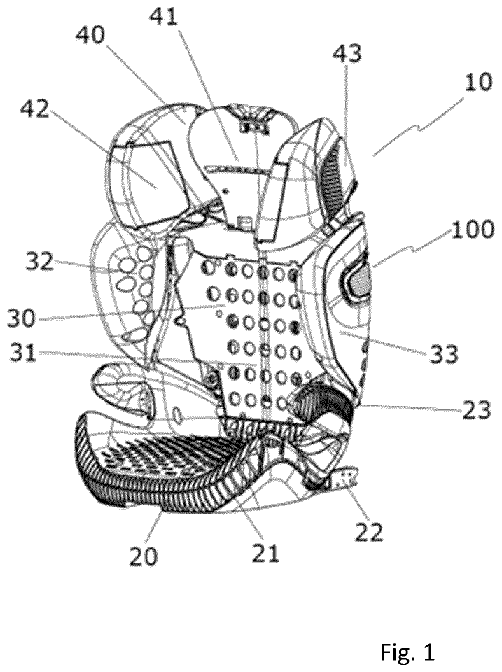

FIG. 1 a schematic oblique view of a child seat according to the invention;

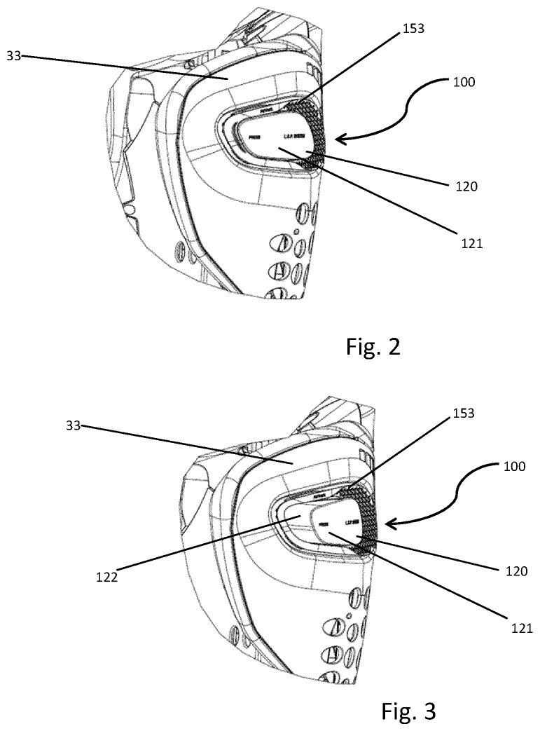

FIG. 2 a section of the child seat according to FIG. 1;

FIG. 3 the section of the child seat according to FIG. 2 in a different configuration;

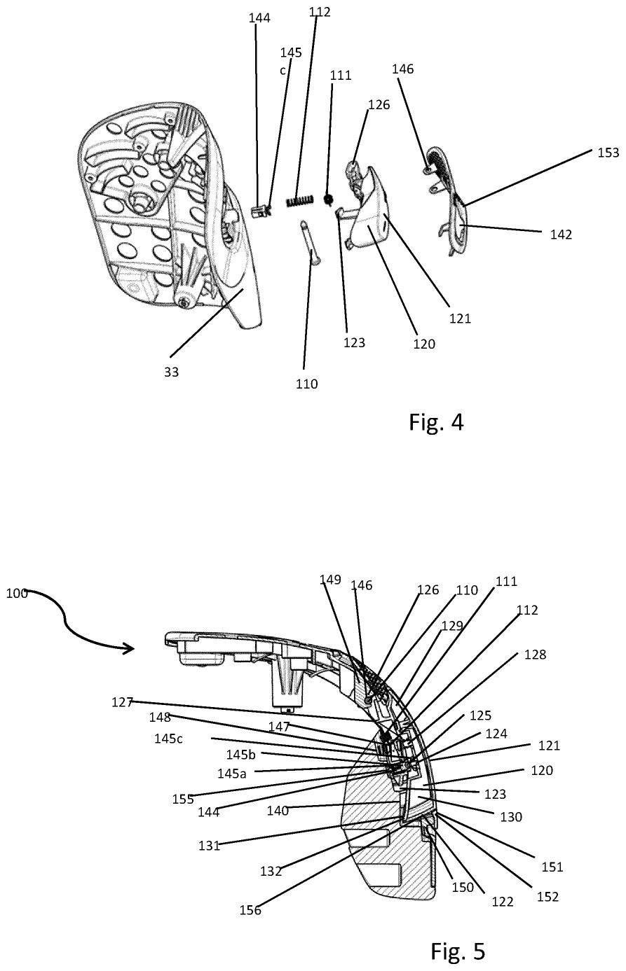

FIG. 4 an exploded view of parts of the child seat according to FIG. 1-3;

FIG. 5 a cross-section of a section of the child seat according to FIG. 1-4;

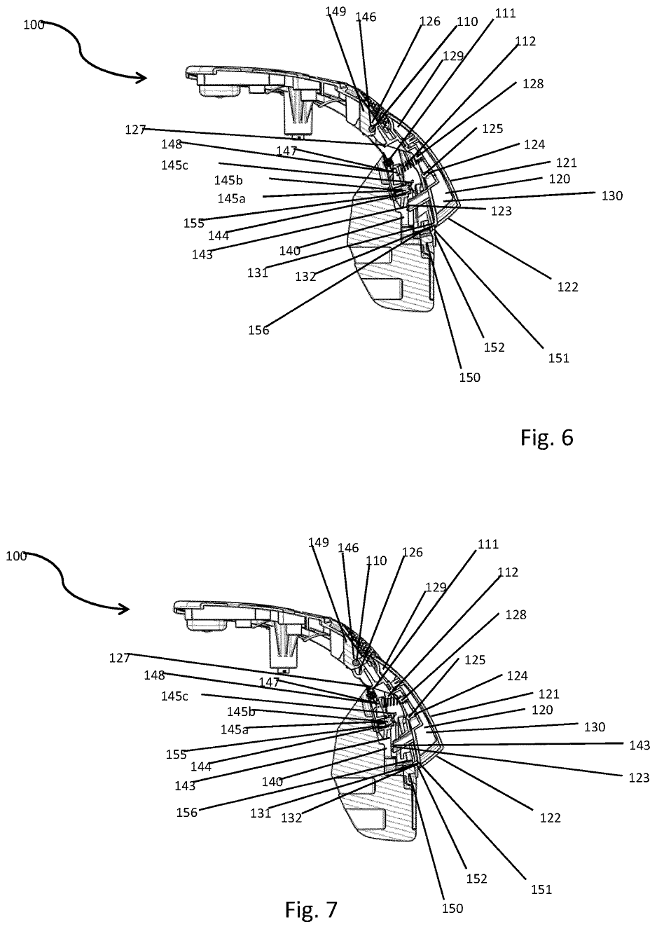

FIG. 6 the section according to FIG. 5 in a different configuration;

FIG. 7 the child seat according to FIGS. 5 and 6 in a further configuration;

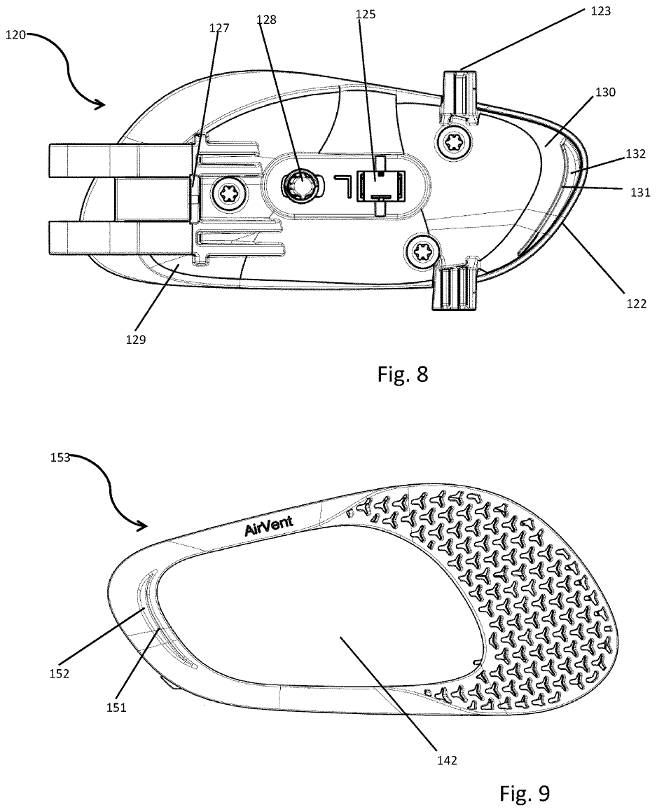

FIG. 8 parts of the side impact protector;

FIG. 9 parts of the side impact protector;

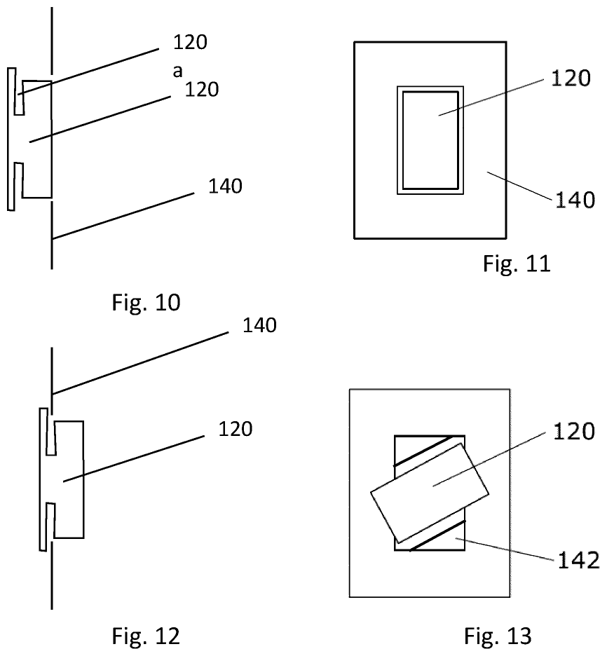

FIG. 10 a section of an alternative embodiment in a schematic sectional view, in part;

FIG. 11 the section according to FIG. 10 in a view from above;

FIG. 12 the section according to FIG. 10 in a different configuration; and

FIG. 13 a view analogous to FIG. 11 in the configuration according to FIG. 12.

In the following description, the same reference numbers are used for identical and similarly acting parts.

FIG. 1 shows a child seat 10 according to the invention. The child seat 10 optionally includes a headrest 40 having a head contact surface 41, a seat area 20 having a seat surface 21, as well as a backrest 30 having a back contact surface 31. The seat area 20 can include fastening means 22 for fastening the child seat 10 to a vehicle seat. The seat area 20 can comprise first side surfaces 24 on its outer side. In addition, side bolsters 32 are formed on the backrest 30, which have second side surfaces 33 on the outer side of the child seat 10 (the side facing away from the child located in the child seat). A side impact protector structure 100 is formed on each of the second side surfaces 33 of the side bolsters 32. Side wings 42 may be formed on the headrest 40, which have third side surfaces 43 on the outside of the child seat 10.

FIG. 2 shows a side view of a portion of the second side surface 33 of the side bolster 32 of a child seat 10 according to the invention. The side bolster 32 comprises the side impact protector 100, which, among other things, comprises the side element 120 and the side element outer surface 121. As can be seen in FIG. 1 and in particular in FIG. 2, the side impact protector 100 can be embedded in the second side surface 33 of the side bolster 32, so that the side element outer surface 121 merges at least substantially flush with the adjacent portions of the second side surface 33 of the side bolster 32. The side impact protector 100 is here in the first position.

FIG. 3 shows a side view of a portion of the second side surface 33 of the side bolster 32 of a child seat 10 according to the invention. The side impact protector 100 with the side element 120 and the side element outer surface 121 is in this figure in the second position, The side impact protector 100 is no longer embedded in the second side surface 33 of the side bolster 32, but at least partially projects over it. In contrast to the first position the edge surface 122 can be seen now, which projects over the second side surface 33, or protrudes out of the second side surface 33, or sticks out. In this position, the side element outer surface 121 does not merge flush with the adjacent portions of the second side surface 33 of the side bolster 32.

FIG. 4 shows the side impact protector 100 according to the invention as an exploded view. FIG. 5 shows a sectional view. The side impact protector 100 comprises the side element 120, which can be arranged pivotally movable with respect to the side impact protector system base 140 by an axis 110. The side impact protector base 140 is part of the side impact protector 100 and serves as, in particular, fixed (e.g. firmly mounted or attached) counterpart to the movable side element 120. The side impact protector base 140 can at least partially be mounted within the second side surface 33. The side impact protector base 140 may have an opening 142, in which the side element 120 may be at least partially embedded, between its rear portion 149 and its front portion 150.

The side element 120 preferably has a side element axis reception 126 through which the axis 110 can be guided. The side impact protector also has a second spring 112 that forces the side element 120 into a position projecting over, i.e. pushes it to the left (away from the child), and a first spring 111 that pushes the side element 120 into the second position forward (away from the child) along the second side surface 33. In addition, a base holding device 144 may be provided, which is attached to the side impact protector base 140, which locks the side element 110 in a first position, and which can be unlocked to initiate the transfer to the second position.

The base support device 144 may include or consist of a guide portion 145a, in which a movable portion 145b is guided, and arms 145c. Furthermore, an optional frame 153 (which may be part of the side impact protector base 140) is provided, which surrounds the side element 120 in the first position and can serve as a contact surface for the side element 120 in the second position. A side element stop 123 is provided on the side element 120, which limits the side element 120 in the second position against further opening, caused by the second spring 112.

FIG. 5 shows the side impact protector 100 in the first position in section, embedded in the second side surface 33 of the side bolster 32. The axis 110 is firmly connected to the side impact protector base 140 at the base axis reception 146 and runs on a proximal portion 129 of the side element 110 through the (guide-shaped, in particular groove-shaped) side element axis reception 126, and thus supports the side element 120 pivotally movable in relation to the base. The side element axis reception 126 is in particular designed as a guide, in particular groove-shaped, and/or as an elongated hole. In the first position, the axis 110 is located at a distal end of the side element axis reception 126, which end is closer to the distal portion 130 of the side element 120.

The second spring 112 can be connected at one end to the side impact protector base 140 by a second base spring attachment 148 and at the other end to the side element 120 by a second side element spring attachment 128. The second spring 112 can be compressed in the first position and thus press against the side element 120 from the inside. The head 125 of the side element 120 can engage the arms 145c of the base holding device 144, thereby locking the side element 120 against unfolding by the force of the second spring 112 so that it remains in the embedded first position.

The edge surface 122 of the side element 120 abuts at least at a distal portion 130 against the sliding portion 156 of the side impact protector base 140 and is guided by the latter at least partially (during the transition to the second position).

The first spring 111 can be connected at one end to the side impact protector base 140 by a first base spring attachment 147 and at the other end to the side element 120 by a first side element spring attachment 147. The first spring 111 can be stretched in the first position and thus pull on a proximal end of the side element 120 (at the first side element spring attachment 147) and thus push a distal portion of the edge surface 122 to the sliding portion 156.

By application of force (in the direction of the child) to the proximal portion 129 of the side element 120, the movable portion 145b of the base holding portion 144 can be pushed along the guide portion 145a (in the direction of the child), thereby moving the arms 145c into the open position, FIG. 6 shows the side impact protector 100 in a position (in particular an unstable intermediate position) between the first and second positions in section, after being transferred by the second spring 112 (to the left) and before being transferred by the first spring 111 (to the front). In this position, the axis 110 is still at a distal end of the side element axis reception 126. The arms 145c of the base holding device 144 are open, whereby the head 125 of the side element 120 is no longer held by the arms 145c and thus the lock against unfolding of the side element 120 is released. The side element 120 is pushed into the (open, unfolded) position projecting over by the force of the second spring 112. The side element stop 123 abuts against the base stop 143, limiting the unfolding of the side element 120 by the second spring 112. The interaction between the side element stop 123 and the base stop 143 blocks further movement of the side element 120 to the left (away from the child). The distal edge surface 122 of the side element 120 is no longer guided by the sliding portion 156 and projects over the sliding portion 156, and in particular lies outside the sliding portion 156. The movement of the side element 120 forward along the second side surface is no longer restricted in this position, thereby releasing the first spring 111.

FIG. 7 shows the side impact protector 100 in the second position in section, after being transferred by the second spring 112 (to the left) and after being transferred by the first spring 111 (forward). In this position, the axis 110 is located at a proximal end of the side element axis reception 126, which end is closer to the proximal portion 130 of the side element 120. The force of the second spring 112 continues to push the side element 120 into the (open, unfolded) position projecting over. The side element stop 123 continues to abut against the base stop 143 (slightly pushed forward), preventing the side element 120 from unfolding further by means of the second spring 112. By releasing the first spring 111 the side element 120 was pushed forward at the first side element spring attachment 147 (to the second position).

A further forward movement of the side element 120 is prevented by the axis 110 abutting against a proximal end of the side element axis reception 126. In the second position, the distal portion of the edge surface 122 is now located in front of the sliding portion 156, thus preventing unwanted movement of the side element 120 by possible application of force (e.g. crash scenario) from the left (towards the child) back into the embedded first position. In this position, the side element holding engagement 132 engages the base holding portion 151, as well as the base holding engagement 152 engages the side element holding portion 131, thereby locking the side element 120 against sliding back (rearward) upon possible application of force from the front.

FIG. 8 shows the side element 120 from behind. FIG. 10 shows the frame 153.

In FIGS. 10 to 13 an alternative embodiment is shown partly. The side element is displaced (translationally) in the first step and rotated in the second step. For this purpose, the side element can have at least one clearance 120a, e.g. a groove, optionally a circumferential groove.

It should be noted at this point that all parts described above, when viewed individually and in any combination, in particular the details shown in the drawings, are claimed as essential to the invention. Modifications of these are familiar to those skilled in the art.

Furthermore, it should be noted that the broadest possible scope of protection is sought. In this respect, the invention defined in the claims can also be specified by features that are described with further features (without these further features necessarily being included). It is explicitly pointed out that round brackets and the term ‘in particular’ are intended to emphasise the optional nature of features in the respective context, which does not mean, conversely, that a feature is to be regarded as mandatory in the corresponding context without such identification.

### REFERENCE SIGNS

10 child seat
11 accommodation space
20 seat area
21 seat surface
22 fastening means
23 arm rests
24 first side surfaces
25 lap belt guide
30 backrest
31 back contact surface
32 side bolster
33 second side surfaces
40 headrest
41 head contact surface
42 side wing
43 third side surfaces
44 shoulder belt guide
100 side impact protector
110 axis
111 first spring
112 second spring
120 side element
120a clearance
121 side element outer surface
122 edge surface
123 side element stop
124 side element holding device
125 head
126 side element axis reception
127 first side element spring attachment
128 second side element spring attachment
129 proximal portion
130 distal portion
131 side element holding portion
132 side element holding engagement
133 inner part
134 outer part
140 base
141 base outer surface
142 opening
143 base stop
144 base holding device
145a guide portion
145b movable portion
145c arms
146 base axis reception
147 first base spring attachment
148 second base spring attachment
149 rear portion
150 front portion
151 base holding portion
152 base holding engagement
153 frame
154 bridge
155 holding device reception
156 slide portion

1. A child seat for mounting on a motor vehicle seat, wherein the child seat has at least one side surface and a side impact protector, wherein the side impact protector comprises:
a side impact protector base, and
a side element that is movable with respect to the side impact protector base and is transferable from an inoperative position, in particular located within a predetermined width of the child seat, to a functional position, in particular located outside the predetermined width,
wherein the side element in the functional position projects over the side surface in the lateral direction, wherein the side element in the inoperative position does not project over the side surface or projects less far than in the functional position, wherein position transfer means are provided to enable transfer from the inoperative position to the functional position and are configured such that, in a first step, a lateral projection over the side surface can be at least substantially determined and, in a second step, the side element or at least one displacement portion of the side element, the weight of which preferably corresponds to at least 15 wt.-% of the total weight of the side element or which is at least partially visible in the inoperative position, is displaceable, in particular slidable, preferably such that the side element comes to rest at least in sections over a portion of the side surface adjacent the side element.

2. The child seat according to claim 1,
wherein
the side element or its displacement portion are moveable during the second step at least substantially transversely to the lateral direction or substantially along the adjacent side surface.

3. The child seat according to claim 1,
wherein
the side element is rotatable during the first step about a fixed or movable axis, or the side element or its displacement portion is displaceable during the second step.

4. The child seat according to claim 1,
wherein
the first step or the second step, optionally after releasing a lock, occur(s) automatically, assisted by at least one spring, more preferably at least one first spring for assisting the second step or at least one second spring for assisting the first step.

5. The child seat according to claim 1,
wherein
the functional position or the inoperative position can be locked.

6. The child seat according to claim 1,
wherein
the side element and the side impact protector base form a pair of complementary engagement structures, in particular at least one projection-recess-pair, which impedes a transfer from the functional position into the inoperative position, such that that the inhibition can be overcome by a force of less than or equal to 50 N, more preferably less than or equal to 10 N or greater than or equal to 0.1 N, preferably greater than or equal to 0.5 N, optionally greater than or equal to 1 N.

7. The child seat according to claim 1,
wherein
the side element or the displaceable portion is foldable backwards during the first step or can be displaced forwards during the second step.

8. The child seat according to claim 1,
wherein
the side impact protector is provided at least partially, optionally completely, in a back portion of the child seat, in particular to the rear of a back contact surface, or above a seat portion of the child seat or on an outer side of a seat shell.

9. The child seat according to claim 1,
wherein
the side element is made of an at least substantially rigid material.

10. A method for adjusting a side impact protector of a child seat according to claim 1, wherein the child seat has at least one side surface and a side impact protector, wherein the side impact protector comprises:
a side impact protector base, and
a side element that is moveable with respect to the side impact protector base and is transferable from an inoperative position, in particular located within a predetermined width of the child seat, to a functional position, in particular located outside the predetermined width,
wherein the side element in the functional position projects over the side surface in the lateral direction,
wherein the side element in the inoperative position does not project over the side surface or projects less far than in the functional position,
wherein in a first step a lateral projection over the side surface is at least substantially determined and in a second step at least a portion of the side element, the weight of which preferably corresponds to at least 15 wt.-% of the total weight of the side element of which is at least partially visible in the inoperative position, is slid in such a way that the side element comes to rest at least in sections over a portion of the side surface adjacent the side element.
